(19) United States
(12) Patent Application Publication
(10) Pub. No.: US 2016/0226083 A1
(43) Pub. Date: Aug. 4, 2016

(54) Method For Connecting An Electrically Conductive Contact Element To At Least One Electrically Conductive Fuel Cell Component Which Is Associated With A Fuel Cell

(71) Applicant: SIEMENS AKTIENGESELLSCHAFT, Muenchen (DE)

(72) Inventors: Horst Greiner, Forchheim (DE); Andre Leonide, Fuerth (DE)

(73) Assignee: Siemens Aktiengesellschaft, Muenchen (DE)

(21) Appl. No.: 15/021,127

(22) PCT Filed: Aug. 28, 2014
(86) PCT No.: PCT/EP2014/068210

§ 371 Date: Mar. 10, 2016

(30) Foreign Application Priority Data
Sep. 10, 2013 (DE) 10 2013 218 053.5

(51) Int. Cl. H01M 8/0297; H01M 8/0236

(52) U.S. Cl. CPC H01M 8/0297; H01M 8/0236; H01M 2004/8689

(57) ABSTRACT

A method is provided for connecting an electrically conductive contact element to at least one electrically conductive fuel cell component associated with a fuel cell. A contact element that is soluable in a solvent, and an electrically conductive fuel cell component are provided. A solvent is applied to the contact element and/or the fuel cell component. The contact element is arranged on the fuel cell component. The solvent is evaporated to form a contact between the contact element and the fuel cell component.

### CROSS-REFERENCE TO RELATED APPLICATIONS

This application is a U.S. National Stage Application of International Application No. PCT/EP2014/068210 filed Aug. 28, 2014, which designates the United States of America, and claims priority to DE Application No. 10 2013 218 053.5 filed Sep. 10, 2013, the contents of which are hereby incorporated by reference in their entirety.

### TECHNICAL FIELD

The invention relates to a method for connecting an electrically conductive contact element to at least one electrically conductive fuel cell component which is associated with a fuel cell.

### BACKGROUND

In the course of the production of a fuel cell, e.g., a high-temperature fuel cell, i.e. a fuel cell having an operating temperature of above 500° C., it is known to connect an electrically conductive contact element, which may in particular assume the form of a contact layer, to an electrically conductive fuel cell component, such as for example an electrode, which is part of or associated with the fuel cell, or to apply an electrically conductive contact element onto a corresponding electrically conductive fuel cell component. The purpose of the electrically conductive contact element is in particular to ensure or improve electrical contacting between the electrically conductive fuel cell component and further electrically conductive components of the fuel cell.

The electrically conductive contact element has hitherto typically been connected to or applied onto the electrically conductive fuel cell component which is associated with the fuel cell by means of wet powder coating methods or screen printing methods.

Wet powder coating methods usually entail laborious masking of the electrically conductive fuel cell component to be coated prior to the actual application of the electrically conductive contact element in order to ensure that the electrically conductive contact element is solely applied onto the regions of the electrically conductive fuel cell component which are to be coated. In screen printing methods, there is a risk that the electrically conductive contact element, which in such methods is applied in paste form, will undesirably run onto uncoated regions of the electrically conductive fuel cell component.

### SUMMARY

One embodiment provides a method for connecting an electrically conductive contact element to at least one electrically conductive fuel cell component which is associated with a fuel cell, comprising providing a contact element that is soluble in a solvent and is electrically conductive at temperatures of above 500° C., and an electrically conductive fuel cell component, applying a solvent for partially or completely dissolving at least the contact element onto at least one of the contact element or the fuel cell component, arranging the contact element on the fuel cell component, and evaporating the solvent to form a connection between the contact element and the fuel cell component.

In a further embodiment, the contact element used is a material formed of lanthanum strontium cobalt ferrite or a material comprising lanthanum strontium cobalt ferrite or a lanthanum strontium manganite or a material comprising lanthanum strontium manganite.

In a further embodiment, an unsintered lanthanum strontium cobalt ferrite or an unsintered lanthanum strontium manganite is used.

In a further embodiment, the contact element used is a sheet-like, e.g., film-like, material.

In a further embodiment, prior to the application of the solvent, the contact element is provided with at least one hole.

In a further embodiment, the solvent used is an organic solvent, e.g., ethanol.

In a further embodiment, an emulsion of solvent and material that forms the contact element dissolved therein is used as the solvent.

In a further embodiment, the electrically conductive fuel cell component used is an electrode, e.g., a cathode.

Another embodiment provides a fuel cell, e.g., a high-temperature fuel cell, comprising at least one electrically conductive fuel cell component and at least one electrically conductive contact element connected thereto as disclosed above.

### BRIEF DESCRIPTION OF THE DRAWINGS

Example embodiments of the invention are described below with reference to the drawings, in which:

FIGS. 1-3 each show a schematic diagram of a contact element and a fuel cell component in the course of carrying out a method according to an example embodiments of the invention; and

FIG. 4 shows a schematic diagram of portion of a fuel cell.

### DETAILED DESCRIPTION

Embodiments of the present invention provide an improved method for applying or connecting an electrically conductive contact element to at least one electrically conductive fuel cell component which is associated with a fuel cell.

Some embodiments provide a method including the following steps:
providing a contact element which is soluble in a solvent as well as an electrically conductive fuel cell component,
applying a solvent onto the contact element and/or the electrically conductive fuel cell component,
arranging the contact element on the electrically conductive fuel cell component,
evaporating the solvent to form a connection between the contact element and the fuel cell component.

In some embodiments, a first step involves providing a contact element which is soluble in a solvent as well as an electrically conductive fuel cell component, such as an electrode, e.g., a cathode, which is associated or associable with a fuel cell, e.g., a high-temperature fuel cell having an operating temperature of above 500° C., e.g., between 600 and 1000° C.

An electrically conductive contact element should be taken to mean an element which, on the basis of the material nature or chemical/physical structure thereof, has electrically conductive properties, e.g., electron conductivity, e.g., in the range of the operating temperature of a fuel cell or high-temperature fuel cell, such as at temperatures of above 500° C., e.g., between 600 and 1000° C. The electrically conductive contact element typically assumes the form of a (thin) film or layer.

The electrically conductive contact element has a material nature or chemical/physical structure that is soluble in a specific solvent which is to be specified in greater detail below, i.e. which, when wetted with the solvent, is partially or completely soluble and may thus be converted at least at the surface from a solid into a liquid state of matter. The electrically conductive contact element provided in the first step of the method according to the invention is therefore formed of a material which is soluble in a solvent or comprises such a material.

In a second step of the method subsequent to the first step, a solvent is applied onto the contact element and/or the fuel cell component. Care must here be taken to ensure sufficient wetting of the contact element and/or the fuel cell component with the solvent in order in the further course of the method to achieve a sufficiently robust connection between the contact element and the fuel cell component. It goes without saying that the solvent used in this step is a solvent which is suitable for partially or completely dissolving at least the contact element. The solvent is therefore conveniently selected as a function of the material nature or chemical/physical structure of the contact element.

It may be sufficient to apply the solvent at least in places onto the contact element or at least in places onto the fuel cell component. The connection between the contact element and the fuel cell component may, however, generally be improved by applying solvent both onto the contact element and onto the fuel cell component. The solvent may be applied onto the side of the contact element facing the fuel cell component and/or the side of the contact element remote from the fuel cell component.

The solvent may, for example, be applied with a paintbrush, by spraying or by pouring. It is also conceivable to dip the contact element to be wetted with the solvent and/or the fuel cell component to be wetted with the solvent or the portions of the surface thereof which are a part thereof and are to be wetted, into a bath of a solvent. It goes without saying that application techniques other than those mentioned may in principle also be used to apply the solvent onto the contact element and/or the fuel cell component.

In a third step of the method subsequent to the second step, the contact element is arranged on the electrically conductive fuel cell component. Once arranged on the fuel cell component, the contact element lies at least in portions, e.g., completely, extensively or directly on the fuel cell component.

In a fourth step of the method subsequent to the third step, the solvent is evaporated to form a connection between the contact element and the fuel cell component. It is in this step that a connection is actually formed between the contact element and the fuel cell component. The connection is in principle an adhesive bond between the two parts to be joined which is produced by means of a solvent adhesive. The connection produced by evaporation of the solvent is therefore generally materially bonded and accordingly correspondingly robust.

The connection between the contact element and the fuel cell component produced by evaporation of the solvent may be created comparatively simply and quickly, such that the method is a highly efficient way, e.g., in manufacturing terms, of producing a connection between a corresponding contact element and a corresponding fuel cell component. The rapid formation of the connection between the contact element and the fuel cell component may also be advantageous for the handling characteristics of the component assembly produced by the method which is or is to be associated with a fuel cell.

The solvent evaporation process proceeds under normal or standard conditions, e.g., at room temperature (approx. 25° C.) and a pressure of 1 atm, generally by itself. The solvent evaporation process may optionally be controlled or assisted or accelerated by purposefully establishing specific process conditions, such as for example pressure and/or temperature.

Once the contact element has been connected to the fuel cell component, it is conceivable for further fuel cell components, such as for example an interconnector plate, which are associated or associable with the fuel cell, to be applied or connected to the contact element. The method for connecting an electrically conductive contact element to at least one electrically conductive fuel cell component which is associated with a fuel cell may accordingly be part of a method for producing a fuel cell, e.g., a high-temperature fuel cell.

A contact element formed of or comprising a metal oxide is typically used in the course of the disclosed method. An electrically conductive contact element may be formed of a lanthanum strontium cobalt ferrite, abbreviated to LSCF, e.g., of formula LaₓSr₁₋ₓCo_{y}Fe_{1-y}O_{3-d}, or an electrically conductive contact element comprising lanthanum strontium cobalt ferrite, abbreviated to LSCF, e.g., of formula LaₓSr₁₋ₓCo_{y}Fe_{1-y}O_{3-d}, is used. The electrically conductive contact element used may alternatively also be formed of lanthanum strontium manganite, abbreviated to LSM, e.g., of formula La₁₋ₓSrₓMnO₃, or comprise lanthanum strontium manganite, abbreviated to LSM, e.g., of formula La₁₋ₓSrₓMnO₃.

The fuel cell component may be formed of the same material as the contact element. The fuel cell component may thus for example likewise be formed of lanthanum strontium cobalt ferrite, abbreviated to LSCF, e.g., of formula LaₓSr₁₋ₓCo_{y}Fe_{1-y}O_{3-d}, or comprise lanthanum strontium cobalt ferrite, abbreviated to LSCF, e.g., of formula LaₓSr₁₋ₓCo_{y}Fe_{1-y}O_{3-d}.

The material which forms the electrically conductive contact element used in the course of the method is conveniently unsintered and thus not brittle, so simplifying the handling characteristics and processability of the contact element in the course of the method.

The electrically conductive contact element used in the course of the method may be a sheet-like, e.g., film-like, element or material. The contact element may accordingly assume the form of a sheet or, e.g., a film and thus in principle have a planar geometry. Using a contact element in the form of a film has the advantage that the contact element may have particularly thin construction and thus does not substantially modify the overall structure of a fuel cell with regard to the dimensions thereof. The thickness or height of the contact element is for example in the range between 50 and 300 μm, e.g., in the range between 100 and 200 μm.

In the course of the method, the electrically conductive contact element may be provided with at least one opening or hole prior to the application of the solvent. The openings or holes may be introduced into the contact element by punching processes. The geometric form of the contact element may accordingly be adapted to further components, such as for example interconnector plates, which in the overall structure of a fuel cell adjoin the side of the contact element remote from the fuel cell component. The surface contour of the contact element may thus conveniently be adapted to the surface contour of a component, such as for example an interconnector plate, which in the overall structure of the fuel cell is to be arranged on the contact element or connected thereto, or be of corresponding, i.e. in particular complementary, construction to said component.

The solvent used in the course of the method may be an organic solvent, e.g., ethanol. In principle, however, taking account of the material nature or chemical/physical structure of the contact element, it is also possible to use other, e.g., organic, solvents. If the contact element is formed of lanthanum strontium cobalt ferrite or comprises lanthanum strontium cobalt ferrite, ethanol has, however, proved particularly suitable for the purposes intended.

In some embodiments, a specific quantity of the material is dissolved to form the contact element in the solvent prior to the application thereof onto the contact element and/or the fuel cell component. The solvent accordingly assumes the form of an emulsion of solvent with material which forms the contact element dissolved therein. In proportional terms, the dissolved material which forms the contact element occupies a proportion by volume in the emulsion in the range of 10-40%, e.g., approximately 20%. Using such a solvent which assumes the form of an emulsion makes it possible to improve the robustness of the connection between the contact element and the fuel cell component.

Other embodiments of the invention provide a fuel cell, e.g., a high-temperature fuel cell, such as a fuel cell having an operating temperature of above 500° C., e.g., in the range of between 600 and 1000° C., comprising at least one electrically conductive fuel cell component, such as an electrode, e.g., a cathode, and at least one electrically conductive contact element connected thereto in accordance with the method described above. Accordingly, the explanations regarding the fuel cell according to the invention apply mutatis mutandis in connection with the method according to the invention.

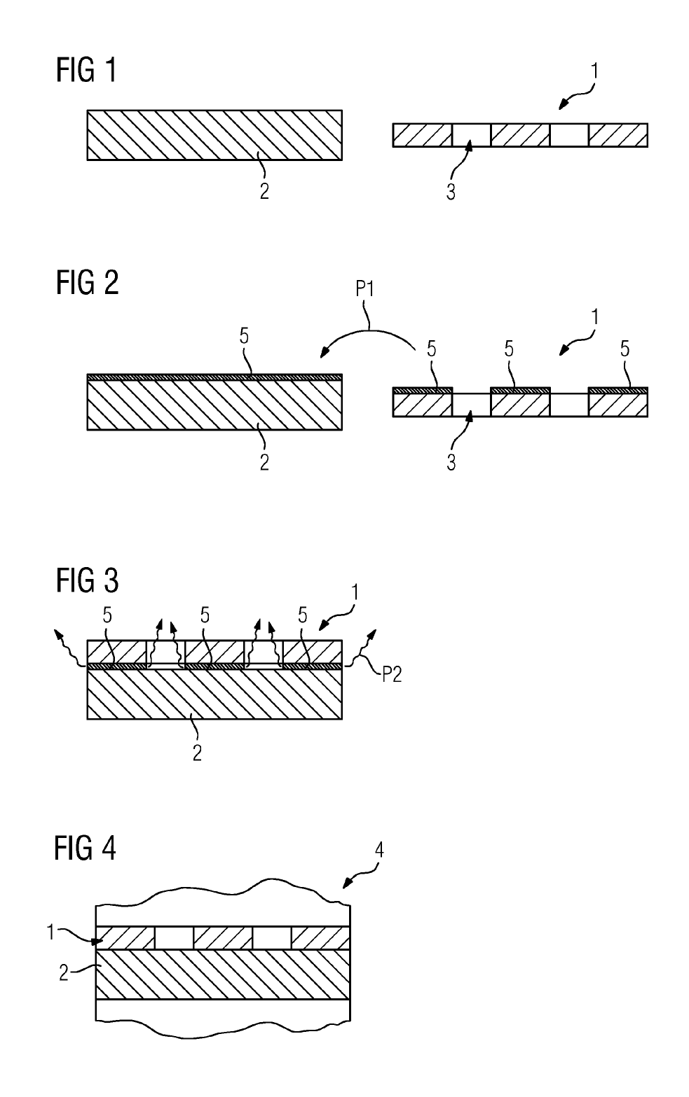

FIGS. 1-3 each show a schematic diagram of an electrically conductive contact element 1 and an electrically conductive fuel cell component 2 in the course of carrying out a method according to an example embodiment of the invention. FIGS. 1-3 each show a sectional view of the contact element 1 and of the fuel cell component 2.

FIG. 1 shows the provision provided in the first step of the method of a contact element 1 and a fuel cell component 2. In the further course of the method, the contact element 1 is to be applied onto the fuel cell component 2 or connected robustly or captively thereto (cf. FIGS. 2 and 3).

The contact element 1 is formed of unsintered lanthanum strontium cobalt ferrite, formula LaₓSr₁₋ₓCo_{y}Fe_{1-y}O_{3-d}. The contact element 1 assumes the form of a film with a thickness or height of approximately 100 μm.

Holes 3 formed in the contact element 1 are visible. The holes 3, which may be formed by punching processes, and the consequently achieved form of the contact element 1 are adapted to further components, such as for example interconnector plates, which in the overall structure of a fuel cell 4 (cf. FIG. 4) adjoin the side of the contact element 1 remote from the fuel cell component 2. In comparison with the surface contour of a component which in the overall structure of the fuel cell 4 is to be arranged on or connected to said component, the surface contour of the contact element 1 is thus typically of complementary construction.

The fuel cell component 2 is a porous electrode, connected as the cathode, for a fuel cell or of a fuel cell (cf. FIG. 4). The fuel cell component 2 is likewise formed of lanthanum strontium cobalt ferrite, formula LaₓSr₁₋ₓCo_{y}Fe_{1-y}O_{3-d}. In contrast with the material which forms the contact element 1, the material which forms the fuel cell component 2 is, however, already sintered. It is, however, in principle also possible to use a material which forms the fuel cell component 2 which is non-sintered.

FIG. 2 shows the application of a liquid organic solvent 5 in the form of an emulsion or mixture of the material which forms the contact element 1 and ethanol onto the faces of the contact element 1 and of the fuel cell component 2 which are on the top in FIG. 2. The solvent 5 which assumes the form of an emulsion accordingly already contains a certain quantity, typically approximately 20 vol. %, of dissolved material which forms the contact element 1.

On the contact element side, the solvent 5 may be applied onto the side of the contact element 1 facing the fuel cell component 2 and/or the side remote from the fuel cell component 2. The solvent 5 is applied, for example, with a paintbrush. The solvent 5 is suitable for partially or completely dissolving the contact element 1 at least at the surface.

As indicated by arrow P1 shown in FIG. 2, in the further course of the method the contact element 1 is arranged or laid onto the surface of the fuel cell component 2 which has been wetted with the solvent 5.

FIG. 3 shows the state in which the contact element 1 has been arranged correspondingly on the fuel cell component 2. The contact element 1 here lies extensively or directly on the fuel cell component 2. As is apparent in FIG. 3, a certain quantity of the solvent 5 or dissolved contact element 1 is still present between the undissolved part of the contact element 1 and the fuel cell component 2.

In a subsequent step of the method, the solvent 5 is vaporized or evaporated, as indicated by arrows P2. The evaporation process of the solvent 5 may be controlled or accelerated by purposefully establishing specific process conditions, such as for example pressure and/or temperature.

FIG. 4 finally shows the state in which the solvent 5 has completely vaporized or evaporated. A component assembly has now been obtained which is or may be used in a fuel cell 4, e.g., a high-temperature fuel cell having an operating temperature of above 500° C., e.g., between 600 and 1000° C. (cf. FIG. 4).

The structure of a fuel cell 4 or of a stack of a plurality of fuel cells 4 arranged on or adjacent to one another is sufficiently known. In general, an interconnector plate (not shown) adjoins the upper side of the contact element 1 while an electrolyte (not shown) adjoins the underside of the fuel cell component 2.

Although the invention has been illustrated and described in greater detail with reference to the preferred exemplary embodiment, the invention is not restricted by the disclosed examples and other variations may be derived therefrom by a person skilled in the art without going beyond the scope of protection of the invention.

What is claimed is:

1. A method for connecting an electrically conductive contact element to at least one electrically conductive fuel cell component which is associated with a fuel cell, comprising:
providing a contact element that is soluble in a solvent and is electrically conductive at temperatures of above 500° C., and an electrically conductive fuel cell component,
applying a solvent for partially or completely dissolving at least the contact element onto at least one of the contact element and/or the fuel cell component,
arranging the contact element on the fuel cell component, and
evaporating the solvent to form a connection between the contact element and the fuel cell component.

2. The method of claim 1, wherein the contact element used is a material formed of lanthanum strontium cobalt ferrite or a material comprising lanthanum strontium cobalt ferrite or a lanthanum strontium manganite or a material comprising lanthanum strontium manganite.

3. The method of claim 2, wherein an unsintered lanthanum strontium cobalt ferrite or an unsintered lanthanum strontium manganite is used.

4. The method of claim 1, wherein the contact element used is a sheet-like material.

5. The method of claim 1, wherein, prior to the application of the solvent, the contact element is provided with at least one hole.

6. The method of claim 1, wherein the solvent used is an organic solvent.

7. The method v, wherein an emulsion of solvent and material that forms the contact element dissolved therein is used as the solvent.

8. The method of claim 1, wherein the electrically conductive fuel cell component used is an electrode.

9. (canceled)

10. The method of claim 1, wherein the contact element used is a film-like material.

11. The method of claim 1, wherein the solvent used is ethanol.

12. The method of claim 1, wherein the electrically conductive fuel cell component used is a cathode.

13. A fuel cell comprising:
at least one electrically conductive fuel cell component, and
at least one electrically conductive contact element connected to the at least one electrically conductive fuel cell component by a process including:
providing a contact element that is soluble in a solvent and is electrically conductive at temperatures of above 500° C., and an electrically conductive fuel cell component,
applying a solvent for partially or completely dissolving at least the contact element onto at least one of the contact element or the fuel cell component,
arranging the contact element on the fuel cell component, and
evaporating the solvent to form a connection between the contact element and the fuel cell component.

14. The fuel cell of claim 13, wherein the fuel cell is a high-temperature fuel cell.
